(19) United States
(12) Patent Application Publication
(10) Pub. No.: US 2021/0194662 A1
(43) Pub. Date: Jun. 24, 2021

(54) FULL-DUPLEX DATA TRANSMISSION METHOD AND APPARATUS

(71) Applicant: HUAWEI TECHNOLOGIES CO., LTD., Shenzhen (CN)

(72) Inventors: Yuchen GUO, Shenzhen (CN); Peter LOC, Cupertino, CA (US); Ming GAN, Shenzhen (CN)

(21) Appl. No.: 17/191,993

(22) Filed: Mar. 4, 2021

Related U.S. Application Data
(63) Continuation of application No. PCT/CN2019/103192, filed on Aug. 29, 2019.

(30) Foreign Application Priority Data
Sep. 6, 2018 (CN) 201811035956.X

(51) Int. Cl. H04L 5/14; H04W 74/08

(52) U.S. Cl. CPC H04L 5/14; H04W 74/0833

(57) ABSTRACT

Embodiments of the present disclosure disclose example full-duplex data transmission methods and an example full-duplex data transmission apparatus. One example method includes: A first signal is sent by an access point to at least one first station. Information used to indicate at least one full-duplex TXOP is included in the first signal. A first data frame to the first station is sent by the access point based on the first signal. A second data frame is received by the access point from at least one second station. Transmission time intervals of the first data frame and the second data frame are included in a same full-duplex TXOP among the at least one full-duplex TXOP, and the transmission time intervals of the first data frame and the second data frame have a nonempty intersection set.

### CROSS-REFERENCE TO RELATED APPLICATIONS

This application is a continuation of International Application No. PCT/CN2019/103192, filed on Aug. 29, 2019, which claims priority to Chinese Patent Application No. 201811035956.X, filed on Sep. 6, 2018. The disclosures of the aforementioned applications are hereby incorporated by reference in their entireties.

### TECHNICAL FIELD

This application relates to the field of communications technologies, and in particular, to a full-duplex data transmission method and apparatus.

### BACKGROUND

With development of wireless communication technologies, wireless communication devices affect all production and household aspects. With the exponential increase of wireless devices and the scarcity of wireless spectrum resources, it is crucial to improve utilization efficiency of a wireless spectrum. In a full-duplex (full-duplex, FD) wireless communication technology, users in different uplink and downlink transmission directions can simultaneously transmit data on a same wireless channel. The full-duplex wireless communication technology may improve spectrum utilization, and is one of potential technologies of next-generation (next generation, NG) wireless fidelity (wireless fidelity, WiFi).

In the conventional technology, an access point (access point, AP) may send a trigger frame to a station (station, STA) to trigger full-duplex transmission between the access point and the station. Specifically, when the access point needs to send downlink data to the station, and the access point knows that the station has to-be-sent uplink data, the access point may send the trigger frame to the station. Then, the station sends data to the access point after a period of time that exists after the station receives the trigger frame, and the access point also sends data to the station, so as to implement full-duplex transmission.

However, in the conventional technology, the access point can send the trigger frame to the station to trigger the full-duplex transmission only when the access point knows that the station has to-be-sent uplink data. When the access point does not know which station has to-be-sent uplink data, the access point cannot send a trigger frame to the station to trigger full-duplex transmission, and the access point can only independently send the downlink data. Consequently, a resource waste is caused.

### SUMMARY

This application provides a full-duplex data transmission method and apparatus, to resolve a resource waste problem that occurs because an access point does not know which stations have to-be-sent uplink data and cannot trigger full-duplex transmission.

According to a first aspect, this application provides a full-duplex data transmission method. The method includes: An access point sends a first signal to at least one first station, where the first signal includes information used to indicate at least one full-duplex transmit opportunity TXOP. The access point sends a first data frame to the at least one first station based on the first signal. The access point receives a second data frame sent by at least one second station. Transmission time intervals of the first data frame and the second data frame are included in a same full-duplex TXOP among the at least one full-duplex TXOP, and the transmission time intervals of the first data frame and the second data frame have a nonempty intersection set.

For the access point, the full-duplex TXOP means that in the full-duplex TXOP, the access point may not only send downlink data to a station, but also may receive uplink data sent by the station.

In this embodiment, before the access point communicates with the station, the access point sends the first signal to the station to indicate the at least one full-duplex TXOP. Further, the station associated with the access point is notified that full-duplex transmission may be performed. between the access point and the station, so that the access point can send the first data frame to the first station in the full-duplex TXOP, and receive the second data frame sent by the second station. This implements the full-duplex transmission between the access point and the station, avoids a problem that the access point independently sends the downlink data because the station does not know that full-duplex transmission is to be performed between the access point and the station, and avoids the resource waste problem.

In a possible implementation, the first signal is a transfer request frame, and the transfer request frame represents that the access point requests to send the first data frame to the at least one first station. After the access point sends the first signal to the at least one first station, the method further includes: The access point receives a second signal sent by the at least one first station, where the second signal is a clear to send frame, and the clear to send frame represents that the at least one first station prepares to receive first data frame.

In a possible implementation, that the access point receives a second data frame sent by at least one second station includes: The access point receives the second data frame sent by the at least one second station in a carrier sense multiple access with collision avoidance manner. The station is allowed to send the uplink data to the access point in the carrier sense multiple access with collision avoidance manner, and the access point no longer needs to send a trigger frame for random access to the station, so that signaling overheads are reduced, and transmission efficiency of the uplink data is improved.

In a possible implementation, the first signal further includes one or a combination of the following: first allow-to-send indication information, second allow-to-send indication information, and first indication information. The first allow-to-send indication information is used to indicate whether the second station is allowed to send the uplink data in the full-duplex TXOP, the second allow-to-send indication information is used to indicate whether the first station is allowed to send the uplink data in the full-duplex TXOP and the first indication information is used to indicate the second station to ignore a state in which a channel is busy in the full-duplex TXOP. “Ignoring” the state in which the channel is busy may be understood as that in the full-duplex TXOP when the second station senses that the channel is busy, data transmission may still be performed. The first station and/or the second station are/is allowed to send the uplink data in the full-duplex TXOP, so that the access point can control which stations to send the uplink data, and the access point can implement more fine-grained full-duplex control.

In a possible implementation, when the second allow-to-send indication information indicates that the first station is allowed to send the uplink data in the full-duplex TXOP, the full-duplex data transmission method further includes: The access point receives, in the full-duplex TXOP, a third data frame sent by the first station. The access point allows the first station to send the uplink data in the full-duplex TXOP, so that the first station can not only receive the downlink data sent by the access point, but also send the uplink data, thereby improving data transmission efficiency.

In a possible implementation, the full-duplex data transmission method further includes: The access point sends a trigger frame for random access to the at least one second station, where the trigger frame for random access is used to indicate a resource block used by the at least one second station to transmit the second data frame. The second station may send the uplink data to the access point based on the resource block indicated by the trigger frame for random access. In addition, the access point sends the trigger frame for random access to the station, to trigger the station to transmit the uplink data, and the access point sends the downlink data to the station at the same time, so as to implement full-duplex transmission.

In a possible implementation, the first signal further includes one or a combination of the following: second indication information, third indication information, and fourth indication information. The second indication information is used to indicate the at least one full-duplex TXOP, the third indication information is used to indicate that only a station that does not receive the second signal is allowed to send the uplink data, and the fourth indication information is used to indicate that a station whose receive power for receiving the second signal is less than a preset threshold is allowed to send the uplink data It is stipulated that only a station that does not receive the second signal can perform random access transmission after receiving the trigger frame for random access. Alternatively, only a station whose receive power for receiving a second signal frame is less than the preset threshold can initiate random access transmission after receiving the trigger frame for random access. This can avoid data interference between stations, for example, avoid relatively large interference caused by uplink data transmission of the second station to the first station.

According to a second aspect, this application provides a full-duplex data transmission method. The method includes: A second station receives a first signal sent by an access point, where the first signal includes information used to indicate at least one full-duplex transmit opportunity TXOP. The second station generates a second data frame. The second station sends the second data frame to the access point. Transmission time intervals of the second data frame and a first data frame are included in a same full-duplex TXOP among the at least one full-duplex TXOP. The first data frame is sent by the access point to at least one first station. The transmission time intervals of the first data frame and the second data frame have a nonempty intersection set.

In a possible implementation, the first signal is a transfer request frame, and the transfer request frame represents that the access point requests to send the first data frame to the at least one first station.

In a possible implementation, that the second station sends the second data frame to the access point includes: The second station sends the second data frame to the access point in a carrier sense multiple access with collision avoidance manner.

In a possible implementation, the first signal further includes one or a combination of the following: first allow-to-send indication information, second allow-to-send indication information, and first indication information. The first allow-to-send indication information is used to indicate whether the second station is allowed to send uplink data in the full-duplex TXOP, the second allow-to-send indication information is used to indicate whether the first station is allowed to send the uplink data in the full-duplex TXOP, and the first indication information is used to indicate the second station to ignore a state in which a channel is busy in the full-duplex TXOP. That the second station sends the second data frame includes: When the first allow-to-send indication information indicates that the second station is allowed to send the uplink data in the full-duplex TXOP, the second station sends the second data frame to the access point.

In a possible implementation, after the second station sends the second data frame to the access point, the method further includes: If the second station detects that a state of a channel is busy, the second station waits for the channel state to change from busy to idle. When determining that the channel state changes from busy to idle, the second station starts a block acknowledgment frame timeout mechanism.

In a possible implementation, the block acknowledgment frame timeout mechanism is used to indicate the access point to send an acknowledgment frame to the second station after the first station sends the first data frame.

In a possible implementation, the full-duplex data transmission method further includes: The second station receives a trigger frame for random access sent by the access point, where the trigger frame for random access is used to indicate a resource block used by the second station to transmit the second data frame.

In a possible implementation, the trigger frame for random access includes resource indication information, where the resource indication information indicates at least one resource block, and the resource block is used by the second station to transmit the uplink data through random access.

In a possible implementation, the first signal further includes one or a combination of the following: second indication information, third indication information, and fourth indication information. The second indication information is used to indicate the at least one full-duplex TXOP, the third indication information is used to indicate that only a station that does not receive a second signal is allowed to send the uplink data, and the fourth indication information is used to indicate that a station whose receive power for receiving the second signal is less than a preset threshold is allowed to send the uplink data. The second signal is sent by the first station to the access point, the second signal is a clear to send frame, and the clear to send frame represents that the first station prepares to receive the first data frame.

According to a third aspect, this application provides a full-duplex data transmission method. The method includes: A station sends a first signal to an access point, where the first signal includes information used to indicate first duration of a full-duplex transmit opportunity TXOP. The station receives a second signal sent by the access point, where the second signal includes information used to indicate second duration of the full-duplex TXOP. The second duration is greater than the first duration. The station determines, based on the first duration and the second duration, that duration of the full-duplex TXOP is greater than the first duration, and the duration of the full-duplex TXOP is greater than the second duration.

In a possible implementation, the full-duplex data transmission method further includes: The station sends a first data frame to the access point, where the first data frame includes a preamble part, the preamble part includes first indication information, and the first indication information is used to indicate a transmission time interval of the first data frame. The station receives a second data frame sent by the access point, where an end time of the second data frame is the same as an end time of the first data frame. The station receives a first acknowledgment frame sent by the access point, and sends a second acknowledgment frame to the access point.

In a possible implementation, the first signal further includes second indication information, and the second indication information is used to indicate whether the second signal sent by the access point can increase the duration.

The station interacts with the access point, and the station sends the first signal to the access point, where the first signal indicates the first duration of the full-duplex TXOP. The access point sends the second signal to the station, where the second signal indicates the second duration of the full-duplex TXOP. The second duration is greater than the first duration. When a data frame sent by the access point to the station needs relatively long duration, or the access point needs to send a plurality of data frames to the station, both the station and the access point determine that the duration of the full-duplex TXOP is greater than the first duration, and the duration of the full-duplex TXOP is greater than the second duration. The duration of the full-duplex TXOP is prolonged, so that the access point reserves, based on a traffic volume of the access point, more time channels to send data.

According to a fourth aspect, this application provides a full-duplex data transmission method. The method includes: An access point receives a first signal sent by a station, where the first signal includes information used to indicate first duration of a full-duplex transmit opportunity TXOP. The access point sends a second signal to the station, where the second signal includes information used to indicate second duration of the full-duplex TXOP. The second duration is greater than the first duration. The access point determines, based on the first duration and the second duration, that duration of the full-duplex TXOP is greater than the first duration, and the duration of the full-duplex TXOP is greater than the second duration.

In a possible implementation, the full-duplex data transmission method further includes: The access point receives a first data frame sent by the station, where the first data frame includes a preamble part, the preamble part includes first indication information, and the first indication information is used to indicate a transmission time interval of the first data frame. The access point determines an end time of a second data frame based on the first indication information. The access point sends the second data frame to the station, where the end time of the second data frame is the same as an end time of the first data frame. The access point sends a first acknowledgment frame to the station, and receives a second acknowledgment frame sent by the station.

In a possible implementation, the first signal further includes second indication information, and the second indication information is used to indicate whether the second signal sent by the access point can increase the duration.

According to a fifth aspect, this application provides a full-duplex data transmission apparatus. The apparatus may be an access point, or may be a chip in an access point. The apparatus has a function of implementing the embodiments related to the access point in the foregoing aspects. The function may be implemented by hardware, or may be implemented by hardware by executing corresponding software. The hardware or the software includes one or more units corresponding to the foregoing function.

In a possible design, when the apparatus is an access point, the access point includes a processing module, a receiving module, and a sending module. The processing module may be, for example, a processor, the receiving module may be, for example, a receiver, and the sending module may be, for example, a transmitter. The receiver includes a radio frequency circuit, and the transmitter includes a radio frequency circuit. Optionally, the access point further includes a storage unit, and the storage unit may be, for example, a memory. When the access point includes a storage unit, the storage unit is configured to store a computer executable instruction, the processing module is connected to the storage unit, and the processing module executes the computer executable instruction stored in the storage unit, so that the apparatus performs the full-duplex data transmission method related to the function of the access point in the first aspect.

In another possible design, when the apparatus is a chip in an access point, the chip includes a processing module, a receiving module, and a sending module. The processing module may be, for example, a processor, the receiving module may be, for example, an input interface, a pin, or a circuit on the chip, and the sending module may be, for example, an output interface, a pin, or a circuit on the chip. The processing module may execute a computer executable instruction stored in a storage unit, so that the chip in the access point performs the full-duplex data transmission method related to the function of the access point in the foregoing aspects. Optionally, the storage unit is a storage unit in the chip, for example, a register or a cache. The storage unit may alternatively be a storage unit, for example, a read-only memory (read-only memory, ROM for short) or another type of static storage device that can store static information and an instruction, or a random access memory (random access memory, RAM for short), that is in the access point and that is located outside the chip.

The processor mentioned in any one of the foregoing designs may be a. universal central processing unit (Central Processing Unit, CPU for short), a microprocessor, an application-specific integrated circuit (application-specific integrated circuit, ASIC for short), or one or more integrated circuits configured to control program execution of the foregoing full-duplex data transmission method.

According to a sixth aspect, this application provides a full-duplex data transmission apparatus. The apparatus may be a station, or may be a chip in a station. The apparatus has a function of implementing the embodiments related to the access point in the foregoing aspects. The function may be implemented by hardware, or may be implemented by hardware by executing corresponding software. The hardware or the software includes one or more units corresponding to the foregoing function.

In a possible design, when the apparatus is a station, the apparatus includes a processing module, a receiving module, and a sending module. The processing module may be, for example, a processor, the receiving module may be, for example, a receiver, and the sending module may be, for example, a transmitter. The receiving module may include a radio frequency circuit and a baseband circuit, and the sending module may include a radio frequency circuit and a baseband. circuit.

Optionally, the apparatus may further include a storage unit, and the storage unit may be, for example, a memory. When the apparatus includes a storage unit, the storage unit is configured to store a computer executable instruction, the processing module is connected to the storage unit, and the processing module executes the computer executable instruction stored in the storage unit, so that the apparatus performs the full-duplex data transmission method related to the function of the station.

In another possible design, when the apparatus is a chip in a station, the chip includes a processing module, a receiving module, and a sending module. The processing module may be, for example, a processor, the receiving module/sending module may be, for example, an input/output interface, a pin, or a circuit on the chip. Optionally, the apparatus may further include a storage unit, and the processing module may execute a computer executable instruction stored in the storage unit, so that the chip in the apparatus performs the full-duplex data transmission method. related to the function of the station in the second aspect.

Optionally, the storage unit is a storage unit in the chip, for example, a register or a cache. The storage unit may further be a storage unit, for example, a ROM, another type of static storage device that can store static information and an instruction, or a RAM, that is in the station and that is outside the chip.

The processor mentioned in any one of the foregoing designs may be a CPU, a microprocessor, an ASIC, or one or more integrated circuits configured to control program execution of the full-duplex data transmission method in the foregoing aspects.

According to a seventh aspect, a computer storage medium is provided. The computer storage medium stores program code, and the program code is used to indicate an instruction for performing the method in the first aspect or any possible implementation of the first aspect.

According to an eighth aspect, a processor is provided. The processor is configured to be coupled to a memory, and is configured to perform the method in the first aspect, the fourth aspect, or any possible implementation of the first aspect and the fourth aspect.

According to a ninth aspect, a computer program product including an instruction is provided. When the computer program product runs on a computer, the computer is enabled to perform the method in the first aspect, the fourth aspect, or any possible implementation of the first aspect and the fourth aspect.

According to a tenth aspect, a computer storage medium is provided. The computer storage medium stores program code, and the program code is used to indicate an instruction for performing the method in the second aspect, the third aspect, or any possible implementation of the second aspect and the third aspect.

According to an eleventh aspect, a processor is provided. The processor is configured to be coupled to a memory, and is configured to perform the method in the second aspect, the third aspect, or any possible implementation of the second aspect and the third aspect.

According to a twelfth aspect, a computer program product including an instruction is provided. When the computer program product runs on a computer, the computer is enabled to perform the method in the second aspect, the third aspect, or any possible implementation of the second aspect and the third aspect.

### BRIEF DESCRIPTION OF DRAWINGS

FIG. 1 is a schematic diagram of full-duplex transmission;

FIG. 2 is a schematic diagram of a scenario according to an embodiment of this application;

FIG. 3 is an interaction diagram of a full-duplex data transmission method according to an embodiment of this application;

FIG. 4 is a schematic diagram 1 of a transmission direction of a full-duplex data transmission method according to an embodiment of this application;

FIG. 5 is a schematic diagram 2 of a transmission direction of a full-duplex data transmission method according to an embodiment of this application;

FIG. 6 is a schematic diagram of a frame structure of a full-duplex transfer request frame according to an embodiment of this application;

FIG. 7 is an interaction diagram of another full-duplex data transmission method according to an embodiment of this application;

FIG. 8 is a schematic diagram 1 of a transmission direction of another full-duplex data transmission method according to an embodiment of this application;

FIG. 9 is a schematic diagram 2 of a transmission direction of another full-duplex data. transmission method according to an embodiment of this application;

FIG. 10 is an interaction diagram of still another full-duplex data transmission method according to an embodiment of this application;

FIG. 11 is a schematic diagram of a transmission direction of still another full-duplex data transmission method according to an embodiment of this application;

FIG. 12 is an interaction diagram of yet another full-duplex data transmission method according to an embodiment of this application;

FIG. 13 is a schematic diagram of a transmission direction of yet another full-duplex data transmission method according to an embodiment of this application;

FIG. 14 is a schematic block diagram of a full-duplex data transmission apparatus 1400 on an access point side according to an embodiment of this application;

FIG. 15 is a schematic block diagram of another full-duplex data transmission apparatus 1500 on an access point side according to an embodiment of this application;

FIG. 16 is a schematic block diagram of a full-duplex data transmission apparatus 1600 on a station side according to an embodiment of this application; and

FIG. 17 is a schematic block diagram of another full-duplex data transmission apparatus 1700 on a station side according to an embodiment of this application.

### DESCRIPTION OF EMBODIMENTS

Terms used in implementations of this application are merely intended to explain specific embodiments of this application, and are not intended to limit this application.

It should be understood that, the technical solutions of the embodiments of this application may be used in various communications systems, for example, a wireless local area network (wireless local area network, WLAN) communications system, a global system for mobile communications (global system for mobile communications, GSM), a code division multiple access (code division multiple access, CDMA) system, a wideband code division multiple access (wideband code division multiple access, WCDMA) system, a general packet radio service (general packet radio service, GPRS), a long term evolution (long term evolution, LTE) system, an LIE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communications system, a 5G communications system, or another system that may occur in the future. The following describes some terms in this application, to facilitate understanding of a person skilled in the art. For ease of description, the embodiments of this application are described by using the WLAN communications system as an example, and do not constitute a limitation on this application. In addition, it should be noted that when the solutions in the embodiments of this application are used in another system, names of a station and an access point may change, but this does not affect implementation of the solutions in the embodiments of this application.

The following describes the technical solutions in the embodiments of this application with reference to the accompanying drawings.

First, technical terms used in this application are explained.

(1) A station (station, STA) is also referred to as a station device. The station may be a device that provides a user with voice and/or data connectivity, for example, a handheld device or a vehicle-mounted device with a wireless connection function. The station may alternatively be a device for detecting data, for example, a sensor. The station may alternatively be an intelligent device, for example, a smart household device or a wearable device deployed indoors. Common terminal devices include, for example, an air quality monitoring sensor, a temperature sensor, a smoke sensor, a mobile phone, a tablet computer, a notebook computer, a palmtop computer, a mobile internet device (mobile internet device, MID), and a wearable device. The wearable device includes, for example, a smartwatch, a smart band, and a pedometer. The station is a current and future possible wireless communications station or a limited communications station. For example, the station is a MILAN station or a cellular station.

(2) An access point (access point, AP) is also referred to as an access point device. The access point device may be a network device or a radio access network (radio access network, RAN) device. The access point is a device that connects a station to a network by using a licensed spectrum and an unlicensed spectrum, and includes network devices in various communications standards, for example, includes but is not limited to: a wireless access point (for example, a wireless local area network access point), a base station, an evolved NodeB (evolved NodeB, eNB), a radio network controller (radio network controller, RNC), a NodeB (NodeB, NB), a base station controller (base station controller, BSC), a base transceiver station (base transceiver station, BTS), a home network device (for example, a home evolved NodeB, or a home NodeB, HNB), and a baseband unit (baseband unit, BBU).

(3) “A plurality of” indicates two or more, and another quantifier is similar to this.

(4) “Correspondence” may refer to an association relationship or a binding relationship, and that A corresponds to B refers to an association relationship or a binding relationship between A and B. For example, data transmission is performed between the access point and at least one station, that is, the access point is associated with the at least one station.

(5) A transmit opportunity (transmit opportunity, TXOP) is a period of time. For example, if a station obtains a TXOP, the station may directly send data to the access point in a time period of the TXOP, and the station does not need to contend for a channel.

It should be noted that the nouns or terms used in the embodiments of this application may be mutually referenced, and details are not described again.

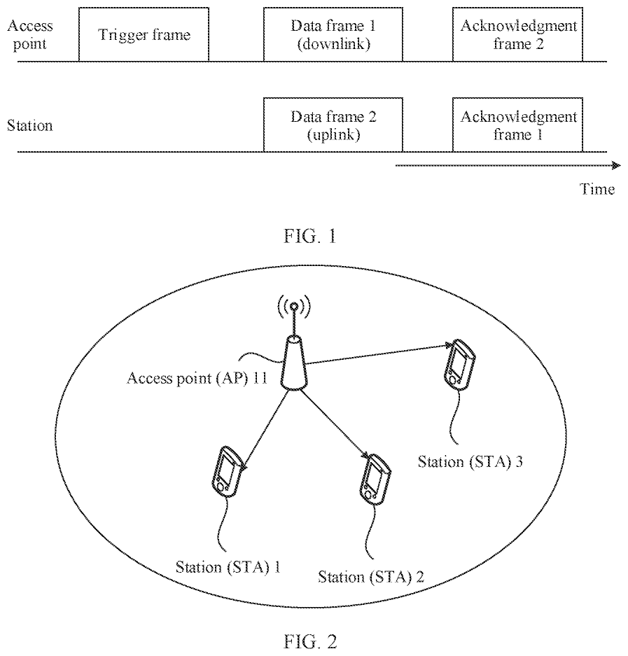

A full-duplex transmission technology is a technology that can effectively improve spectrum efficiency. The full-duplex transmission technology implements transmission of signals in two directions on a same physical channel. To be specific, when a communication duplex node sends a signal, the communication duplex node receives a signal from another node. Compared with the time division duplex and the frequency division duplex, co-frequency co-time full duplex may double the spectral efficiency. FIG. 1 is a schematic diagram of full-duplex transmission. As shown in FIG. 1, when an access point needs to send downlink data to a station, and the access point knows that the station has to-be-sent uplink data, the access point may send a trigger frame to the station, and then the station sends a data frame 1 to the access point after a period of time that exists after the station receives the trigger frame. In addition, the access point also sends a data frame 2 to the station, the access point may send an acknowledgment frame 1 to the station, and the station sends an acknowledgment frame 2 to the access point, to implement full-duplex transmission.

However, in the conventional technology, the access point can send the trigger frame to the station to trigger the full-duplex transmission only when the access point knows that the station has to-be-sent uplink data. When the access point does not know which station has to-be-sent uplink data, the access point cannot send the trigger frame to the station to trigger the full-duplex transmission, and the access point can only independently send the downlink data. Consequently, a resource waste is caused.

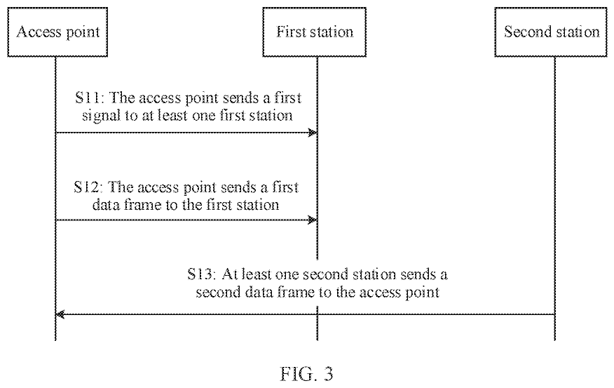

FIG. 2 is a schematic diagram of a scenario according to an embodiment of this application. As shown in FIG. 2, this application relates to at least one access point 11 and one or more stations. Each access point 11 is associated with at least one station, and each access point 11 and a station associated with the access point 11 form a basic service set (basic service set, BSS). For example, as shown in FIG. 2, the access point 11 is associated with a station 1, a station 2, and a station 3.

FIG. 3 is an interaction diagram of a full-duplex data transmission method according to an embodiment of this application. As shown in FIG. 3, the method includes the following steps.

S11: An access point sends a first signal to at least one first station, where the first signal includes information used to indicate at least one full-duplex TXOP.

Optionally, the first signal is any one of the following: a transfer request frame, a channel reservation request frame, and a channel reservation response frame.

For example, data transmission is performed between the access point and at least one station, that is, the access point is associated with the at least one station. In this embodiment, the station associated with the access point includes the at least one first station and at least one second station.

The access point needs to send a downlink data frame to the station associated with the access point, but the access point does not know which stations have to-be-sent uplink data. The access point may send the first signal to the at least one first station associated with the access point, and the first signal indicates the at least one full-duplex TXOP. The first signal indicates that full-duplex transmission may be performed between the access point and the station associated with the access point. To be specific, the access point notifies the station associated with the access point that full-duplex transmission may be performed between the access point and the station in the indicated full-duplex TXOP.

Because the first signal is advertised by the access point, all stations associated with the access point can receive the first signal. For example, the access point broadcasts the first signal.

For the access point, the full-duplex TXOP means that in the full-duplex TXOP, the access point may not only send the downlink data to the station, but also may receive uplink data sent by the station. The station that receives the downlink data sent by the access point and the station that sends the uplink data to the access point may be different stations, or may be a same station. For the station, the station that receives the first signal may determine, based on the information that is included in the first signal and that is used to indicate the full-duplex TXOP, that in the full-duplex TXOP, the station may not only send the uplink data to the access point, but also may receive the downlink data sent by the access point.

The first signal may be a transfer request (transfer request, RTS) frame, or the first signal may be a channel reservation request frame, or the first signal may be a channel reservation response frame.

S12: The access point sends a first data frame to the first station based on the first signal.

For example, the access point first separately sends the first data frame to each first station based on the first signal. In another example, the access point may further send first data frames to different first stations by using orthogonal frequency division multiplexing access (orthogonal frequency division multiplexing access, OFDMA). The first data frames sent to different first stations are the same or different.

For example, for the scenario shown in FIG. 2, both a station 1 and a station 2 are first stations, and a station 3 is a second station. An access point 11 sends the first signal to the station 1 and the station 2. Herein, the access point 11 may also send the first signal to the station 3, but the station 3 does not need to receive a data frame sent by the access point. Then, the access point 11 sends a first data frame to the station 1, and the access point 11 sends a first data frame to the station 2. The first data frame sent to the station 1 and the first data frame sent to the station 2 may be the same or different.

In an example, the first signal includes a duration field, and the duration field is used to indicate duration of the full-duplex TXOP. The station may obtain a start time and an end time of the full-duplex TXOP based on the duration field. Optionally, the first signal may further include an indication field, and the indication field is used to indicate whether the TXOP indicated by the duration field is a full-duplex TXOP.

In another example, a target receiving station of the first signal is a first station, and the first signal may further include an identifier used to indicate the first station. The identifier may be an association identifier (Association Identifier, AID) of the first station, a medium access control (Medium Access Control, MAC) address of the first station, or the like.

S13: The at least one second station each sends a second data frame to the access point.

Transmission time intervals of the first data frame and the second data frame are included in a same full-duplex TXOP among the at least one full-duplex TXOP, and the transmission time intervals of the first data frame and the second data frame have a nonempty intersection set.

For example, the second station may also receive the first signal sent by the access point, and the first signal includes the information indicating the full-duplex TXOP. Further, the second station that receives the first signal may determine that in the full-duplex TXOP, the access point can send the downlink data and receive the uplink data, and then the second station that receives the first signal may send the uplink data to the access point. Second stations each send a second data frame to the access point, where second data frames sent by different second stations may be the same or different.

An execution sequence of step S12 and step S13 is not limited. Alternatively, steps S12 and S13 may be performed at the same time, or step S12 may be performed before step S13, or step S13 may be performed before step S12.

For example, for the scenario shown in FIG. 2, both a station 1 and a station 2 are first stations, and a station 3 is a second station. An access point 11 sends the first signal to the station 1 and the station 2. Herein, the access point 11 may also send the first signal to the station 3, but the station 3 does not need to receive a data frame sent by the access point. Then, the station 3 sends a second data frame to the access point 11.

Transmission time intervals of the first data frame and the second data frame are included in a same full-duplex TXOP among the at least one full-duplex TXOP, and the transmission time intervals of the first data frame and the second data frame have a nonempty intersection set. It is assumed that a transmission time of the first data frame is T1 and an end time is E1, where E1>T1; a transmission time of the second data frame is T2, and an end time is E2, where E2>12; a transmission time interval of the first data frame is [T1, E1], and a transmission time interval of the second data frame is [T2, E2]; the transmission time intervals of the first data frame and the second data frame are included in the full-duplex TXOP. In this case, that the transmission time intervals of the first data frame and the second data frame have a nonempty intersection set includes following several cases:

First case: when T1=T2, and E1=E2, the intersection set is represented as [T1, E1] or [T2, E2].

Second case: when T1<T2, and E1≤E2, the intersection set is represented as [T2, E1].

Third case: when T1≥T2, and E1>E2, the intersection set is represented as [T1, E2].

Fourth case: when T1>T2, and E1<E2, the intersection set is represented as [T1, E1].

Fifth case: when T1<T2, and E1>E2, the intersection set is represented as [T2, E2].

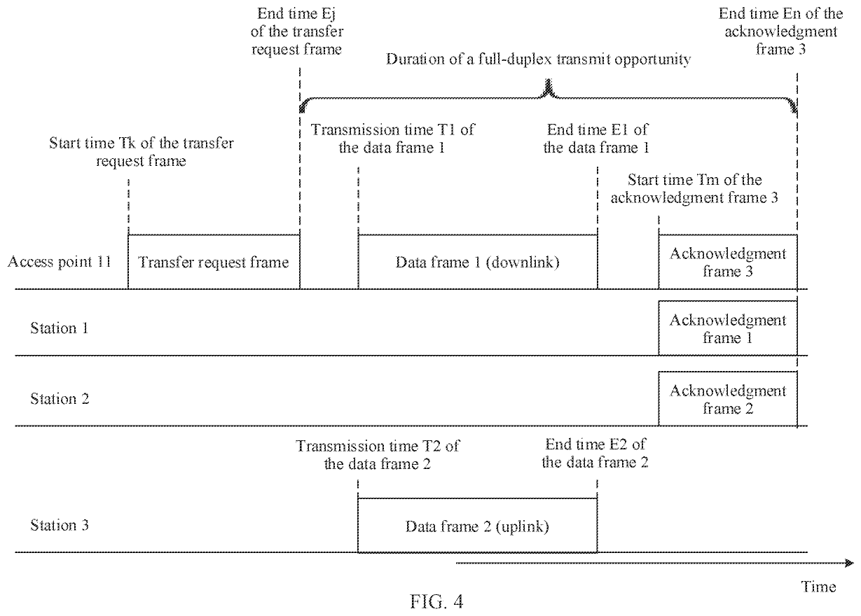

For example, for the scenario shown in FIG. 2, both a station 1 and a station 2 are first stations, and a station 3 is a second station. FIG. 4 is a schematic diagram 1 of a transmission direction of a full-duplex data transmission method according to an embodiment of this application. As shown in FIG. 4, an access point 11 sends a transfer request frame to a station 1 and a station 2. A transmission time of the transfer request frame is Tk, and an end time of the transfer request frame is Ej. The transfer request frame includes first information, the first information indicates a full-duplex TXOP, and the full-duplex TXOP includes a transmission time interval of a data frame 1 and a transmission time interval of a data frame 2. In an example, a transmission time of the data frame 1 is T1, an end time of the data frame 1 is E1, a transmission time of the data frame 2 is T2, and an end time of the data frame 2 is E2, where T1=T2, and E1=E2. The access point 11 separately sends the data frame 1 to the station 1 and the station 2. Because the station 3 may also receive the transfer request frame, the station 3 may determine, based on the transfer request frame, that uplink data may be sent to the access point 11, and the station 3 sends the data frame 2 to the access point 11. The station 1 sends an acknowledgment frame 1 to the access point 11 after a preset time that exists after the station 1 receives the data frame 1. The station 2 sends an acknowledgment frame 2 to the access point 11 after a preset time that exists after the station 2 receives the data frame 1. The access point 11 sends an acknowledgment frame 3 to the station 3 after a preset time that exists alter the access point 11 receives the data frame 2. Because the transmission time T1 of the data frame 1 is equal to the transmission time 12 of the data frame 2, and the end time E1 of the data frame 1 is equal to the end time E2 of the data frame 2, a transmission time of the acknowledgment frame 1, a transmission time of the acknowledgment frame 2, and a transmission time of the acknowledgment frame 3 are the same, and are all Tm. An end time of the acknowledgment frame 1, an end time of the acknowledgment frame 2, and an end time of the acknowledgment frame 3 are the same, and are all En. In this example, duration of the full-duplex TXOP is a time interval [Ej, En], to be specific, the duration of the full-duplex TXOP starts from the end time Ej of the transfer request frame to the end time En of the acknowledgment frame 3.

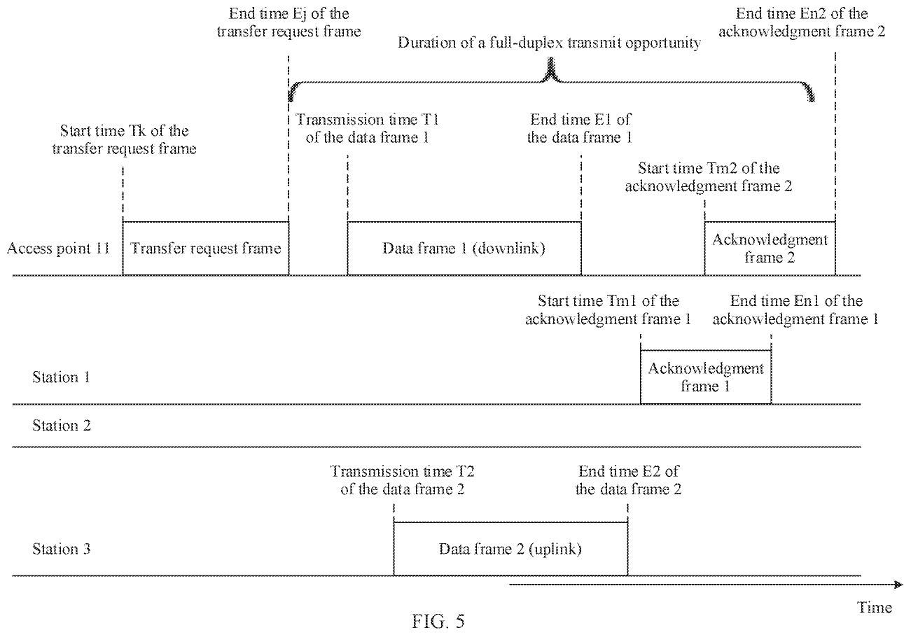

For another example, for the scenario shown in FIG. 2, both a station 1 and a station 2 are first stations, and a station 3 is a second station. FIG. 5 is a schematic diagram 2 of a transmission direction of a full-duplex data transmission method according to an embodiment of this application. As shown in FIG. 5, an access point 11 sends a transfer request frame to the station 1, a transmission time of the transfer request frame is Tk, and an end time of the transfer request frame is Ej. The transfer request frame includes first information, the first information indicates a full-duplex TXOP, and the full-duplex TXOP includes a transmission time interval of a data frame 1 and a transmission time interval of a data frame 2. In an example, a transmission time of the data frame 1 is T1, an end time of the data frame 1 is E1, a transmission time of the data frame 2 is T2, and an end time of the data frame 2 is E2, where T1<T2, and E1<E2. The access point 11 sends the data frame 1 to the station 1. Because the station 3 may also receive the transfer request frame, the station 3 may determine, based on the transfer request frame, that uplink data may be sent to the access point 11, and the station 3 sends the data frame 2 to the access point 11. The station sends an acknowledgment frame 1 to the access point 11 after a preset time that exists after the station 1 receives the data frame 1, where a transmission time of the acknowledgment frame 1 is and an end time of the acknowledgment frame 1 is En1. The access point 11 sends an acknowledgment frame 2 to the station 3 after a preset time that exists after the access point 11 receives the data frame 2, where a transmission time of the acknowledgment frame 2 is Tm2, and an end time of the acknowledgment frame 2 is En2, where Tm1<Tm2, and En1<En2. In this example, duration of the full-duplex TXOP is a time interval [Ej, En2], to be specific, the duration of the full-duplex TXOP starts from the end time Ej of the transfer request frame to the end time En2 of the acknowledgment frame 2.

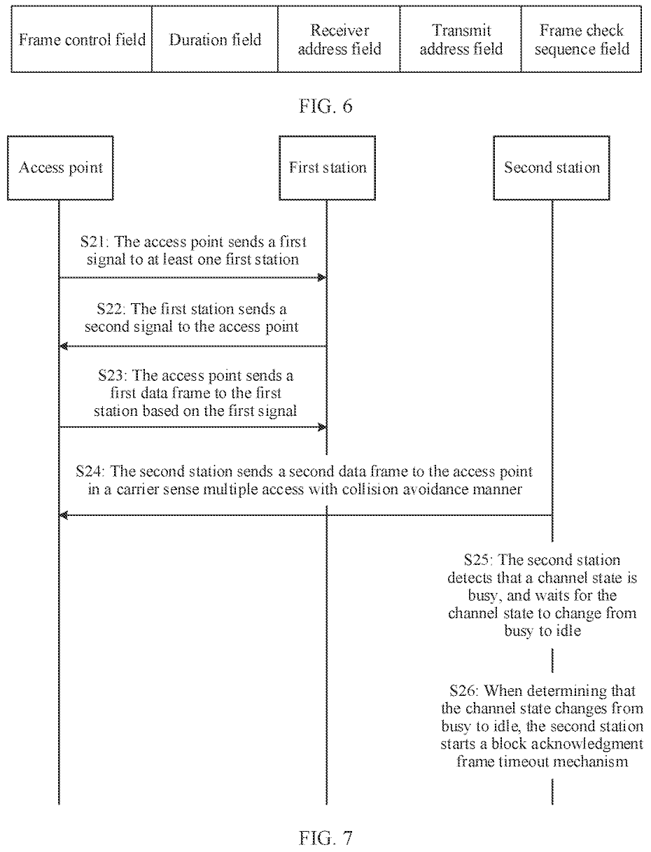

FIG. 6 is a schematic diagram of a frame structure of a transfer request frame according to an embodiment of this application. As shown in FIG. 6, the transfer request frame includes a frame control (frame control) field, a duration (duration) field, and a receiver address (receiver address, RA) field, a transmit address (transmit address, TA) field, and a frame check sequence (frame check sequence, FCS) field. The duration field indicates a full-duplex TXOP. For example, the duration field includes the information used to indicate the full-duplex TXOP, or the duration field includes the full-duplex TXOP. Optionally, an indication field (not shown in FIG. 6) may be added to any location in the transfer request frame. The indication field is used to indicate whether the TXOP indicated by the duration field is a full-duplex TXOP.

In this embodiment, before full-duplex communication is performed between an access point and a station, the access point sends a first signal to the station to indicate at least one full-duplex TXOP. Further, the station associated with the access point is notified that full-duplex transmission may be performed between the access point and the station, so that the access point can send a first data frame to a first station in the full-duplex TXOP, and receive a second data frame sent by a second station. This implements the full-duplex transmission between the access point and the station, avoids a problem that the access point independently sends downlink data because the station does not know that full-duplex transmission is to be performed between the access point and the station, and avoids a resource waste problem.

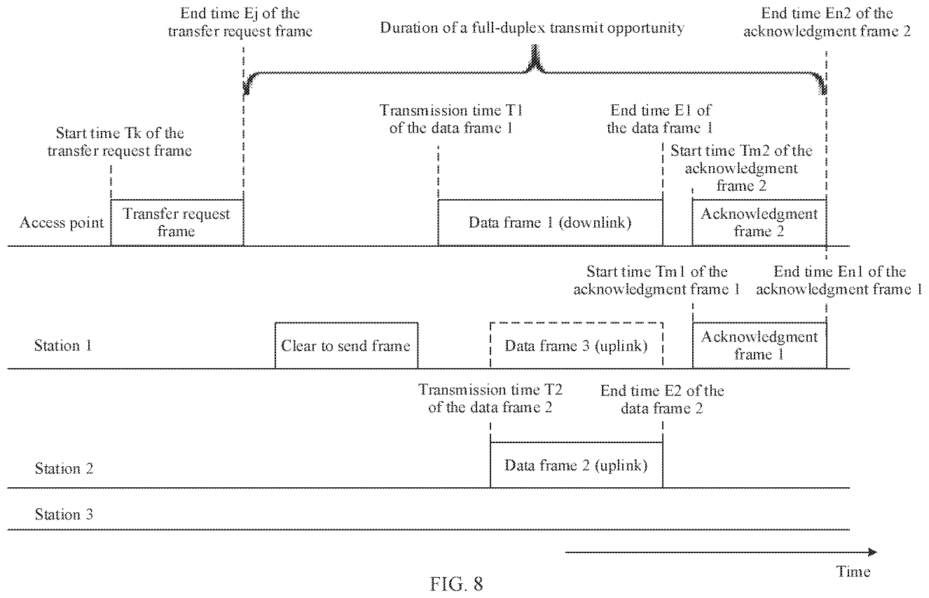

FIG. 7 is an interaction diagram of another full-duplex data transmission method according to an embodiment of this application. As shown in FIG. 7, the method includes the following steps.

S21: An access point sends a first signal to at least one first station, where the first signal includes information used to indicate at least one full-duplex TXOP.

The first signal is similar to that in the foregoing step S11, and details are not described herein again.

Optionally, the first signal is a transfer request frame, and the transfer request frame represents that the access point requests to send a first data frame to the at least one first station.

Optionally, the first signal further includes second indication information, where the second indication information is used to indicate the at least one full-duplex TXOP.

For example, for the step, refer to step S11 in FIG. 3. Specifically, the first signal may be an RTS frame, and the RTS frame represents that the access point requests to send the first data frame to the first station. In addition, the first signal may carry one piece of second indication information, and the second indication information is used to indicate the at least one full-duplex TXOP.

S22: Each of the at least one first station sends a second signal to the access point, where the second signal is a clear to send (clear to send, CTS) frame, and the clear to send frame represents that the at least one first station prepares to receive the first data frame.

For example, after the first station receives the first signal sent by the access point, the first station replies to the access point with the second signal, and the second signal represents that the first station has prepared to receive the first data frame. The second signal may be a CTS frame, or the second signal may be a channel reservation request frame, or the second signal may be a channel reservation response frame. When the second signal is a CTS frame, the CTS frame represents that the first station prepares to receive the first data frame.

S23: The access point sends the first data frame to the at least one first station based on the first

For example, for the step, refer to step S12 in FIG. 3. In addition, after the access point sends the first data frame to the first station based on the first signal, the first station may send a first acknowledgment frame to the access point.

S24: At least one second station sends a second data frame to the access point in a carrier sense multiple access with collision avoidance manner. Transmission time intervals of the first data frame and the second data frame are included in a same full-duplex TXOP among the at least one full-duplex TXOP indicated by the first signal, and the transmission time intervals of the first data frame and the second data frame have a nonempty intersection set.

Optionally, the first signal further includes one or a combination of the following: first allow-to-send indication information, second allow-to-send indication information, and first indication information. The first allow-to-send indication information is used to indicate whether the second station is allowed to send uplink data in the full-duplex TXOP, the second allow-to-send indication information is used to indicate whether the first station is allowed to send the uplink data in the full-duplex TXOP, and the first indication information is used to indicate the second station to ignore a state in which a channel is busy in the full-duplex TXOP.

Optionally, the first signal further includes one or a combination of the following: third indication information and fourth indication information. The third indication information is used to indicate that only a station that does not receive the second signal is allowed to send the uplink data, and the fourth indication information is used to indicate that a station whose receive power for receiving the second signal is less than a preset threshold is allowed to send the uplink data.

For example, the second station may also receive the first signal sent by the access point, and the first signal indicates the information about the full-duplex TXOP. Further, the second station that receives the first signal may determine that in the full-duplex TXOP, the access point can send downlink data and receive the uplink data, and then the second station that receives the first signal may send the uplink data to the access point, The second station may send the second. data frame to the access point in a random access manner by using a carrier sense multiple access with collision avoidance (carrier sense multiple access with collision avoidance, CSMA/CA) manner. Then, after receiving the second data frame sent by the second station, the access point sends a second acknowledgment frame to the second station.

In this embodiment, the first signal sent by the access point to the first station may further include first allow-to-send indication information, and the first allow-to-send indication information indicates whether the second station is allowed to send the uplink data in the full-duplex TXOP. If the first allow-to-send indication information indicates that the second station is allowed to send the uplink data in the full-duplex TXOP, the second station may perform step S24. If the first allow-to-send indication information indicates that the second station is not allowed to send the uplink data in the full-duplex TXOP, the second station cannot perform step S24. Optionally, the first station may alternatively send the uplink data to the access point after step S22. In an example, if the first station is a target receiving station of the first signal, and the second station is not a target receiving station of the first signal, the first allow-to-send indication information may be an identifier of at least 1 bit, and is used to indicate whether a station that is not a target receiving station of the first signal is allowed to send the uplink data. For example, when the first allow-to-send indication information includes one bit, and a value of the bit is 1, it indicates that a non-target receiving station of the first signal is allowed to send the uplink data; or when a value of the bit is 0, it indicates that a non-target receiving station of the first signal is not allowed to send the uplink data. Therefore, based on the first allow-to-send indication information, in the full-duplex TXOP, the access point may control the station that sends the uplink data. In another example, the access point and the station may alternatively agree, based on a protocol, that a target receiving station of the first signal receives, by default, the downlink data sent by the access point in the full-duplex TXOP indicated by the first signal. By default, a non-target receiving station of the first signal is allowed to send the uplink data to the access point in the full-duplex TXOP indicated by the first signal. Therefore, the first signal may alternatively not include the first allow-to-send indication information.

The first signal may further include second allow-to-send indication information, and the second allow-to-send indication information is used to indicate whether the first station is allowed to send the uplink data in the full-duplex TXOP. If the second allow-to-send indication information indicates that the first station is allowed to send the uplink data in the full-duplex TXOP, the first station may also send the uplink data to the access point after step S22. If the second allow-to-send indication information indicates that the first station is not allowed to send. the uplink data in the full-duplex TXOP, the first station does not send the uplink data to the access point, In other words, in this example, an explicit indication manner may be further used to indicate whether the first station is allowed to send the uplink data. Based on the second allow-to-send indication information, in the full-duplex TXOP, the access point may control the station that sends the uplink data.

The first signal may further include first indication information. The first indication information is used to indicate the second station to ignore a state in which a channel is busy in the full-duplex TXOP, that is, the second station may ignore a “busy channel” state caused by transmission performed by the access point. “Ignoring” the state in which the channel is busy means that in the full-duplex TXOP, when the second station senses that the channel is busy, data transmission may still be performed.

The first signal may further include third indication information. The third indication information indicates that only a station that does not receive the second signal is allowed to send the uplink data, that is, only a second station that does not receive the second signal can initiate random access. The second station that does not receive the second signal may perform step S24. Based on this solution, data transmission between another station and the access point can be prevented from causing relatively large interference to the station.

The first signal may further include fourth indication information. The fourth indication information is used to indicate that a station whose receive power for receiving the second signal is less than a preset threshold is allowed to send the uplink data. The preset threshold may exist in the first signal or the second signal, or the preset threshold is broadcast by the first station or the second station. Based on the fourth indication information, data transmission between another station and the access point can be prevented from causing relatively large interference to the station, so that specific spatial isolation between the station and the another station is required. For example, a distance between the station and the another station is relatively large.

For descriptions of the transmission time intervals of the first data frame and the second data frame, refer to step S24 in FIG. 3. Details are not described again.

For example, for the scenario shown in FIG. 2, a station 1 is a first station, and a station 2 and a station 3 are second stations. FIG. 8 is a schematic diagram 1 of a transmission direction of another full-duplex data transmission method according to an embodiment of this application, As shown in FIG. 8, an access point 11 sends a transfer request frame to the station 1. The transfer request frame includes first information, the first information indicates a full-duplex TROP, and the full-duplex TXOP includes a transmission time interval of a data frame 1, a transmission time interval of a data frame 2, and a transmission time interval of a data frame 3. In an example, a transmission time of the data frame 1 is T1, an end time of the data frame 1 is E1, a transmission time of the data frame 2 is T2, and an end time of the data frame 2 is E2, where T1<T2, and

A transmission time of the data frame 3 is T3, and an end time of the data frame 3 is E3, where T3>T2, and E3>E2. The station 2 and the station 3 may also receive a first signal. The station 1 sends a clear to send frame CTS frame to the access point, and the CTS frame represents that the station 1 prepares to receive downlink data sent by the access point. The access point 11 sends the data frame 1 to the station 1. Because the station 2 and the station 3 may also receive the transfer request frame, the station 2 and the station 3 determine, based on the transfer request frame, that the uplink data may be sent in the full-duplex TXOP. The station 2 and the station 3 try to preempt a channel in a carrier sense multiple access with collision avoidance manner, where the station 2 preempts the channel. Further, the station 2 sends the data frame 2 to the access point 11 after a preset backoff time period in the carrier sense multiple access with collision avoidance manner. Because the station 3 does not preempt the channel, the station 3 does not send the uplink data to the access point 11. After the station 1 receives the data frame 1, the station 1 sends an acknowledgment frame 1 to the access point 1, where a transmission time of the acknowledgment frame 1 is Tm1, and an end time of the acknowledgment frame 1 is En1. After the access point 1 receives the data frame 2 sent by the station 2, the access point 11 sends an acknowledgment frame 2 to the station 2, where a transmission time of the acknowledgment frame 2 is Tm2, and an end time of the acknowledgment frame 2 is En2. Because the end time E1 of the data frame 1 is the same as the end time E2 of the data frame 2, the transmission time Tm1 of the acknowledgment frame 1 is equal to the transmission time Tm2 of the acknowledgment frame 2, and the end time Ent of the acknowledgment frame 1 is equal to the end time En2 of the acknowledgment frame 2. In this example, duration of the full-duplex TXOP is a time interval [Ej, En2], to be specific, the duration of the full-duplex TXOP starts from the end time Ej of the transfer request frame to the end time En2 of the acknowledgment frame 3. Optionally, when the second allow-to-send indication information in the transfer request frame indicates that the station 1 is allowed to send. the uplink data in the full-duplex TXOP, after the station 1 sends the CTS frame to the access point, the station 1 having a full-duplex capability may alternatively send a data frame 3 to the access point 11 in the carrier sense multiple access with collision avoidance manner. The station 1 preempts the channel, and the station 2 does not send the data frame 2 to the access point when the station 1 sends the data frame 3.

Optionally, after step S24, the method may further include the following steps.

S25: The second station detects that a channel state is busy, and waits for the channel state to change from busy to idle.

For example, when steps S25 and S26 need to be performed, in step S24, the second station randomly generates a backoff time value, and the second station performs channel backoff within a backoff time indicated by the backoff time value. In a backoff process, if the second station detects that the channel is idle, the backoff time continuously decreases. If the second station detects that the channel is busy, the backoff is suspended, that is, the backoff time remains unchanged. When the channel is idle for a long time, the backoff of the second station ends, and the second station may initiate data transmission, If a plurality of second stations end backoff at a same time, when data transmission is initiated to a same access point, a collision occurs, and resulting in identification of data transmission. Alternatively, when the access point and the second. station end backoff at the same time and initiate respective data transmission at the same time, a data transmission collision may also occur, and resulting in data transmission failures of the access point and the second station.

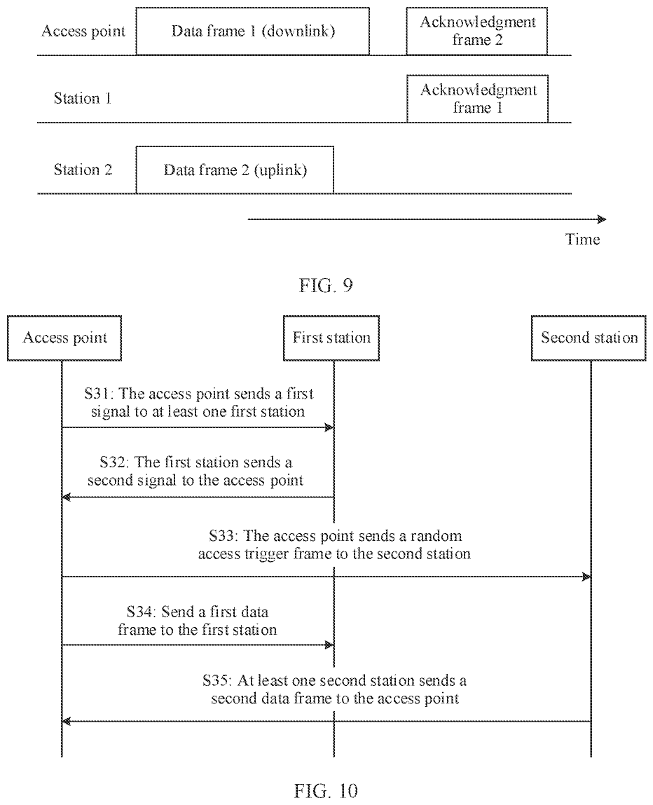

For example, FIG. 9 is a schematic diagram 2 of a transmission direction of another full-duplex data transmission method according to an embodiment of this application. As shown in FIG. 9, when both an access point and a station 2 end backoff at the same time, the access point sends a data frame 1 to a station 1, the station 2 sends a data frame 2 to the access point, the station 1 may send an acknowledgment frame 1 to the access point, and the access point sends an acknowledgment frame 2 to the station 2. If the access point does not have a full-duplex capability, the access point cannot receive data sent by the station 2 because the access point is in a sending state. However, when the access point has a full-duplex capability, the access point may receive, while sending the data frame 1 to the station 1, the data frame 2 sent by the station 2. However, lengths of data frames sent by the access point and the station 2 may be different. For example, a length of the data frame 1 is greater than a length of the data frame 2. Consequently, the access point cannot immediately reply with the acknowledgment frame 2 after receiving the data frame 2, and this is because the access point is sending the data frame 1 to the station 1.

This embodiment provides a manner to resolve a data transmission collision problem.

Further, after a second station sends a second data frame to the access point, if the second station detects that a state of a channel is busy, the second station needs to wait for a change of the channel state.

S26: When determining that the channel state changes from busy to idle, the second station starts a block acknowledgment frame timeout mechanism.

For example, when the second station detects that the channel state changes to idle, the second station starts the block acknowledgment frame timeout (block ACK timeout, BA Timeout) mechanism. The BA timeout mechanism means that after a station sends a data frame, if the station does not receive an acknowledgment frame within a specific time, the station determines that an exception occurs during sending of the data frame, and the station needs to reseed data.

Then, after sending a first data frame to a first station, the access point may send an acknowledgment frame to the second station, and the access point does not need to reply to the first station with an acknowledgment frame after receiving the second data frame sent by the second station. In this way, it is ensured that both uplink data of the first station and uplink data of the second station can be successfully received by the access point. Therefore, a data transmission collision problem can be resolved, a data transmission collision between stations and a data transmission collision between an access point and a station can be avoided, and a probability of a data transmission failure can be reduced.

In this embodiment, before the access point communicates with the station, the access point sends a first signal to the station to indicate at least one full-duplex TXOP. Further, the station associated with the access point is notified that full-duplex transmission may be performed between the access point and the station, so that the access point can send the first data frame to the first station in the full-duplex TXOP, and the access point allows the station to contend, in a CSMA/CA manner, for a channel to send uplink data. This implements the full-duplex transmission between the access point and the station, avoids a problem that the access point independently sends downlink data because the station does not know that full-duplex transmission is to be performed between the access point and the station, and avoids a resource waste problem.

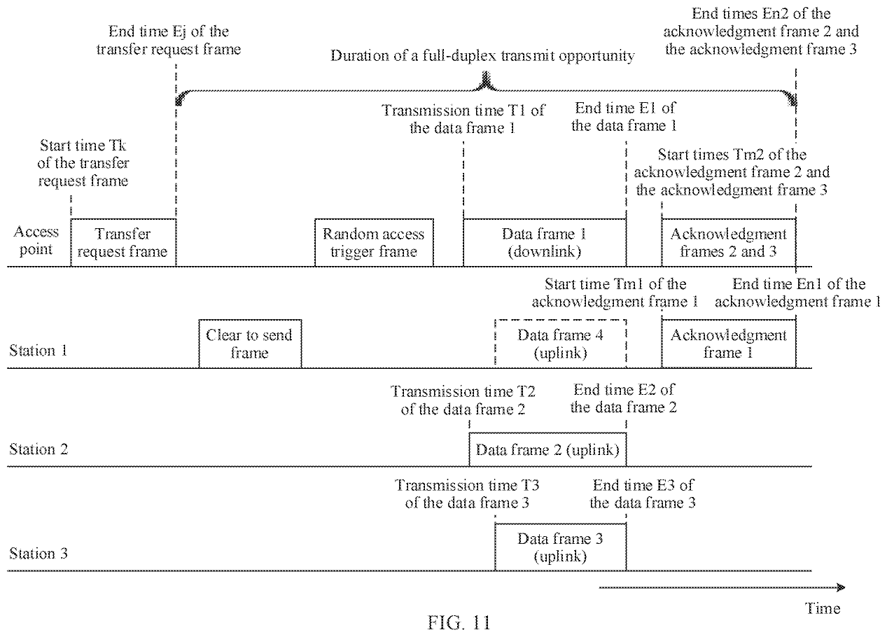

FIG. 10 is an interaction diagram of still another full-duplex data transmission method according to an embodiment of this application. As shown in FIG. 10, the method includes the following steps,

S31: An access point sends a first signal to at least one first station, where the first signal is used to indicate at least one full-duplex TXOP.

Optionally, the first signal is a transfer request frame, and the transfer request frame represents that the access point requests to send a first data frame to the first station.

Optionally, the first signal further includes second indication information, where the second indication information is used to indicate the at least one full-duplex TXOP.

For example, for the step, refer to step S21 in FIG. 7.

S32: The at least one first station each sends a second signal to the access point, where the second signal is a clear to send frame, and the clear to send frame represents that the at least one first station prepares to receive the first data frame.

For example, for the step, refer to step S22 in FIG. 7.

S33: The access point sends a trigger frame for random access to at least one second station, where the trigger frame for random access is used to indicate a resource block used by the at least one second station to transmit a second data frame.

Optionally, the trigger frame for random access includes resource indication information, where the resource indication information indicates at least one resource block, and the resource block is used by a. second station to perform uplink transmission through random access.

For example, after the access point receives the second signal sent by the first station, the access point sends the trigger frame for random access to the second station, to trigger the second station to perform uplink transmission through random access. The trigger frame for random access includes resource indication information, where the resource indication information indicates at least one resource block. For example, the resource indication information is used to allocate at least one resource block. Further, the second station may transmit uplink data by using a resource block through random access.

S34: The access point separately sends the first data frame to the at least one first station based on the first signal.

For example, after step S33, after a period of time, the access point sends the first data frame to the first station. Then, after the first station receives the first data frame sent by the access point, the first station may send a first acknowledgment frame to the access point,

S35: The at least one second station each sends the second data frame to the access point. Transmission time intervals of the first data frame and the second data frame are included in a same full-duplex TXOP among the at least one full-duplex TXOP, and the transmission time intervals of the first data frame and the second data frame have a nonempty intersection set.

Optionally, the first signal further includes: third indication information and fourth indication information. The third indication information is used to indicate that only a station that does not receive the second signal is allowed to send the uplink data, and the fourth indication information is used to indicate that a station whose receive power for receiving the second signal is less than a preset threshold is allowed to send the uplink data.

For example, after the second station receives the trigger frame for random access sent by the access point, after a fixed period of time, the second station randomly selects a resource block through backoff, and sends the second data frame to the access point in a random access manner. Then, after receiving the second data frame sent by the second station, the access point may send a second acknowledgment frame to the second station.

In addition, the first signal may further include third indication information. The third indication information indicates that only a station that does not receive the second signal is allowed to send the uplink data, that is, only a second station that does not receive the second signal can initiate random access. When step S35 is performed, the second station is a station that does not receive the second signal. Data transmission between another station and the access point can be prevented from causing relatively large interference to the station, so that specific spatial isolation between the station and the another station is required. For example, a distance between the station and the another station is relatively large.

The first signal may further include fourth indication information. The fourth indication information is used to indicate that a station whose receive power for receiving the second signal is less than a preset threshold is allowed to send the uplink data. The preset threshold may exist in the first signal or the second signal, or the preset threshold is broadcast by the first station or the second station. Data transmission between another station and the access point can be prevented from causing relatively large interference to the station, so that specific spatial isolation between the station and the another station is required. For example, a distance between the station and the another station is relatively large.

In this embodiment, because the access point sends the trigger frame for random access to the second station, the second station may determine, based on the trigger frame for random access, a resource block that needs to be used for performing uplink transmission, and then the second station sends the second data frame to the access point by using the determined resource block.

For example, for the scenario shown in FIG. 2, a station 1 is a first station, and a station 2 and a station 3 are second stations. FIG. 11 is a schematic diagram of a transmission direction of still another full-duplex data transmission method according to an embodiment of this application. As shown in FIG. 11, an access point 11 sends a transfer request frame to the station 1, a transmission time of the transfer request frame is Tk, and an end time of the transfer request frame is Ej. The transfer request frame includes first information, the first information indicates a full-duplex TXOP, and the full-duplex TXOP includes a transmission time interval of a data frame 1, a transmission time interval of a data frame 2, and a transmission time interval of a data frame 3. In an example, a transmission time of the data frame 1 is T1, an end time of the data frame 1 is E1, a transmission time of the data frame 2 is T2, and an end time of the data frame 2 is F2, where T1=T2, and E1=E2. A transmission time of the data frame 3 is 13, and an end time of the data frame 3 is E3, where T3<T2, and E3=E2. The station 2 and the station 3 may also receive the transfer request frame. The station 1 sends a clear to send CTS frame to the access point, and the CTS frame represents that the station 1 prepares to receive downlink data sent by the access point. The access point 11 sends a trigger frame for random access to the station 2 and the station 3. The access point 11 sends the data frame 1 to the station 1. Because the station 2 may also receive the transfer request frame, the station 2 determines, based on the transfer request frame, that uplink data may be sent in the full-duplex TXOP. The station 2 receives the trigger frame for random access, and determines, based on the trigger frame for random access, a resource block used to send the data frame 2 to the access point 11. Then, the station 2 sends the data frame 2 to the access point 11 based on the resource block. Because the station 3 may also receive the transfer request frame, the station 3 determines, based on the transfer request frame, that the uplink data may be sent in the full-duplex TXOP. In addition, the station 3 receives the trigger frame for random access, and determines, based on the trigger frame for random access, a resource block used to send the data frame 3 to the access point 11. Then, the station 3 sends the data frame 3 to the access point 11 based on the resource block. After the station 1 receives the data frame 1, the station 1 sends an acknowledgment frame 1 to the access point 11, where a transmission time of the acknowledgment frame 1 is Tm1, and an end time of the acknowledgment frame 1 is En1. After the access point 11 receives the data frame 2 sent by the station 2, and receives the data frame 3 sent by the station 3, the access point 11 sends an acknowledgment frame 2 to the station 2, and at the same time, the access point 11 sends an acknowledgment frame 3 to the station 3. Transmission times of the acknowledgment frame 2 and the acknowledgment frame 3 each are Tm2, and end times of the acknowledgment frame 2 and the acknowledgment frame 3 each are En2, where Tm1=Tm2, and En1=En2. In this example, duration of the full-duplex TXOP is a time interval [Ej, En2], to be specific, the duration of the full-duplex TXOP starts from the end time Ej of the transfer request frame to the end times En2 of the acknowledgment frame 2 and the acknowledgment frame 3. Optionally, when second allow-to-send indication information in the transfer request frame indicates that the station 1 is allowed to send the uplink data in the full-duplex TXOP, after the station 1 sends the CTS frame to the access point, the station 1 having a full-duplex capability may send a data frame 4 to the access point 11. Optionally, the access point AP may further send a block acknowledgment frame, to reply to the station 2 and the station 3 with acknowledgment information.

In this embodiment, before full-duplex communication is performed between an access point and a station, the access point sends a first signal to the station to indicate at least one full-duplex TXOP. Further, the station associated with the access point is notified that full-duplex transmission may be performed between the access point and the station, so that the access point can send a first data frame to a first station in the full-duplex TXOP. In addition, the access point sends a trigger frame for random access to a second station, so that the second station can determine, based on the trigger frame for random access, a resource block used to send uplink data. In this way, the second station can send the uplink data to the access point based on the resource block. This implements the full-duplex transmission between the access point and the station, avoids a problem that the access point independently sends downlink data because the station does not know that full-duplex transmission is to be performed between the access point and the station, and avoids a resource waste problem.

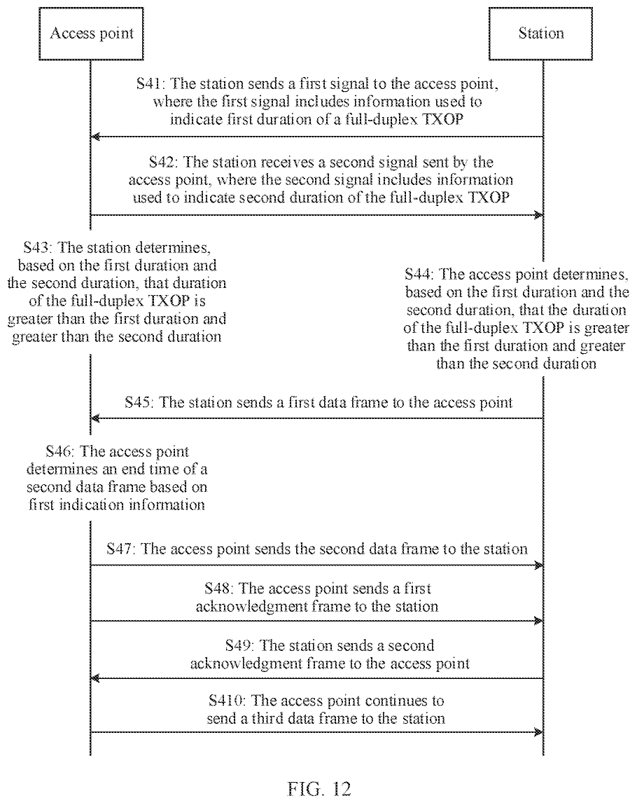

FIG. 12 is an interaction diagram of yet another full-duplex data transmission method according to an embodiment of this application. As shown in FIG. 12, the method includes the following steps.

S41: A station sends a first signal to an access point, where the first signal includes information used to indicate first duration of a full-duplex TXOP.

Optionally, the first signal represents that the station requests to send a first data frame to the access point.

Optionally, the first signal further includes second indication information, and the second indication information is used to indicate whether a second signal sent by the access point can increase duration of the full-duplex TXOP.

For example, the station sends the first signal to the access point, where the first signal is any one of the following: an RTS frame, a channel reservation request frame, and a channel reservation response frame. The first signal includes the information used to indicate the first duration of the full-duplex TXOP. It can be learned that the first duration of the full-duplex TXOP is indicated by the station. In an example, the first signal includes the first duration of the full-duplex TXOP. In another example, the first signal includes one piece of information, and the information indicates the first duration of the full-duplex TXOP.

S42: The station receives the second signal sent by the access point, where the second signal includes information used to indicate second duration of the full-duplex TXOP, and the second duration is greater than the first duration.

Optionally, the second signal represents that the access point prepares to receive the first data frame.

Optionally, the second signal is any one of the following: a CTS frame, a channel reservation request frame, and a channel reservation response frame.

For example, after the station sends the first signal to the access point, the access point sends the second signal to the station, where the second signal includes the information used to indicate the second duration of the full-duplex TXOP. It can be learned that the second duration of the full-duplex TXOP is indicated by the access point. In an example, the second signal includes the second duration of the full-duplex TXOP. In another example, the second signal includes one piece of information, and the information indicates the second duration of the full-duplex TXOP.

In this embodiment, when the access point has more traffic that needs to be processed, that is, the access point needs to send a plurality of data frames to the station, the access point may adjust the duration of the full-duplex TXOP. Because the access point receives the first signal, the access point may determine the first duration of the full-duplex TXOP based on the first signal. When the access point feeds back the second duration of the full-duplex TXOP to the station, the access point may set the second duration to be greater than the first duration. The access point may exchange the first signal and the second signal, to reserve a longer time channel to send data to the station. This is because when the station obtains a channel through contention and the station sends the first signal to the access point, the station reserves, based on a traffic volume of the station, a segment of a time channel to serve as the full-duplex TXOP. However, the access point may have more traffic, that is, the access point needs to send a plurality of data frames to the station, and the access point needs a longer time channel. Further, the access point may adjust the duration of the full-duplex TXOP, and the access point does not use the first duration that is of the full-duplex TXOP and that is indicated by the station as the duration of the full-duplex TXOP.

Because the second indication information in the first signal indicates whether the second signal replied by the access point can increase the duration of the full-duplex TXOP, the station can learn whether the access point adjusts the duration of the full-duplex TXOP, and the station learns that the duration of the full-duplex TXOP needs to be adjusted.

S43: The station determines, based on the first duration and the second duration, that the duration of the full-duplex TXOP is greater than the first duration, and the duration of the full-duplex TXOP is greater than the second duration.

For example, the station does not use the first duration that is of the full-duplex TXOP and that is indicated by the station as the duration of the full-duplex TXOP, and does not use the second duration that is of the full-duplex TXOP and that is indicated by the access point as the duration of the full-duplex TXOP. The station determines that the duration of the full-duplex TXOP is greater than the first duration and greater than the second duration.

S44: The access point determines, based on the first duration and the second duration, that the duration of the full-duplex TXOP is greater than the first duration, and the duration of the full-duplex TXOP is greater than the second duration.

For example, the access point may determine that the duration of the full-duplex TXOP is greater than the first duration and greater than the second duration.

An execution sequence of step S43 and step S44 is not limited. Step S43 and step S44 may be performed at the same time, or step S43 may be performed before step S44, or step S44 may be performed before step S43.

S45: The station sends the first data frame to the access point, where the first data frame includes a preamble part, the preamble part includes first indication information, and the first indication information is used to indicate a transmission time interval of the first data frame.

For example, after the station receives the second signal sent by the access point, the station may determine, based on the second signal, that the access point prepares to receive the first data frame, and then the station sends the first data frame to the access point. The first data frame includes a preamble part, the preamble part includes first indication information, and the first indication information indicates a transmission time interval of the first data frame.

S46: The access point determines an end time of a second data frame based on the first indication information, where the end time of the second data frame is the same as an end time of the first data frame.

For example, because the first indication information indicates the transmission time interval of the first data frame, the access point determines a transmission time and the end time of the first data frame based on the first indication information. Before the access point sends the second data frame to the station, the access point may determine a transmission time interval of the second data frame, and determine that the end time of the second data frame is the same as the end time of the first data frame.

S47: The access point sends the second data frame to the station.

S48: The access point sends a first acknowledgment frame to the station.

For example, the access point and the station each need to send acknowledgment frames to each other. After receiving the first data frame, the access point sends the first acknowledgment frame to the station.

S49: The station sends a second acknowledgment frame to the access point.

For example, after receiving the second data frame, the station sends the second acknowledgment frame to the access point.

S410: The access point continues to send a third data frame to the station.

For example, after the access point and the station complete sending and receiving acknowledgment frames, the station continues to send the third data frame to the access point.

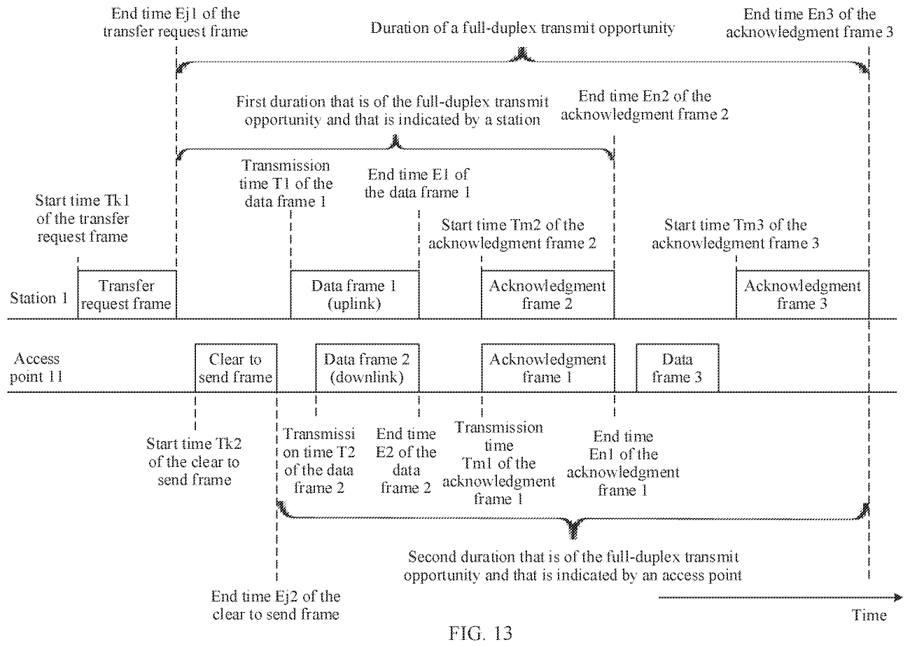

For example, for the scenario shown in FIG. 2, FIG. 13 is a schematic diagram of a transmission direction of yet another full-duplex data transmission method according to an embodiment of this application. As shown in FIG. 13, a station 1 sends a transfer request frame to an access point 11, where the transfer request frame includes first duration of a full-duplex TXOP, a transmission time of the transfer request frame is Tk1, an end time of the transfer request frame is Ej1. The first duration indicates that the duration of the full-duplex TXOP starts from the end. time of the transfer request frame to an end time of an acknowledgment frame 2. The access point 11 may determine the first duration based on the transfer request frame, but the access point 11 needs to send a plurality of data frames to a station 1, and the access point 11 needs to adjust the duration of the full-duplex TXOP. Then, the access point 11 sends a clear to send CTS frame to the station 1, where the CTS frame includes second duration, the second duration is greater than the first duration, and the second duration indicates that the duration of the full-duplex TXOP starts from an end time of the CTS frame to an end time of an acknowledgment frame 3. A transmission time of the CTS frame is Tk2, and the end time of the CTS frame is Ej2. The station 1 may determine, based on the first duration and the second duration, that the duration of the full-duplex TXOP needs to be prolonged, so as to determine the duration of the full-duplex TXOP. In addition, the access point 11 may also determine the duration of the full-duplex TXOP, where the duration of the full-duplex TXOP is greater than the first duration, and the duration of the full-duplex TXOP is greater than the second duration. The station l sends a data frame 1 to the access point 11, where the data frame 1 includes a preamble part, the preamble part includes first indication information, and the first indication information is used to indicate a transmission time interval of the data frame 1. A transmission time of the data. frame 1 is T1 and an end time of the data frame 1 is E1. The access point 11 sends a data. frame 2 to the station 1, where a transmission time of the data. frame 2 is T2, and an end time of the data frame 2 is E2, where T1<T2, and E1=E2. After receiving the data frame 1, the access point 11 sends an acknowledgment frame 1 to the station 1. where a transmission time of the acknowledgment frame 1 is Tm1, and an end time of the acknowledgment frame 1 is En1. In addition, after receiving the data frame 2, the station 1 sends an acknowledgment frame 2 to the access point 11, where a transmission time of the acknowledgment frame 2 is Tm2, and an end time of the acknowledgment frame 2 is En2, where Tm1=Tm2, and En1=En2. The access point 11 continues to send a data frame 3 to the station 1, and after receiving the data frame 3, the station 1 sends an acknowledgment frame 3 to the access point 11, where a transmission time of the acknowledgment frame 3 is Tm3, and an end time of the acknowledgment frame 2 is En3. It can be learned that the first duration that is of the full-duplex TXOP and that is indicated by the station is a time interval [Ej1, En2], to be specific, the first duration starts from the end time Ej1 of the transfer request frame to the end time Ent of the acknowledgment frame 2. Second duration that is of the full-duplex TXOP and that is indicated by the access point is a time interval [Ej2, En3], to be specific, the second duration starts from the end time Ej2 of the CTS frame to the end time En3 of the acknowledgment frame 3. In this example, the duration of the full-duplex TXOP is a time interval [Ej1, En3], to be specific, the duration starts from the end time Ej1 of the transfer request frame to the end time En3 of the acknowledgment frame 3.

In this embodiment, the station is interacted with the access point, so that the station sends the first signal to the access point, where the first signal indicates the first duration of the full-duplex TXOP. When the station sends the first signal to the access point, the station reserves, based on a traffic volume of the station, a segment of a time channel to serve as the full-duplex TXOP. However, the access point may have more traffic, that is, the access point needs to send a plurality of data frames to the station, and the access point needs a longer time channel. Further, the access point may adjust the duration of the full-duplex TXOP, and the access point does not use the first duration that is of the full-duplex TXOP and that is indicated by the station as the duration of the full-duplex TXOP. The access point sends a second signal to the station, where the second signal indicates second duration of the full-duplex TXOP, and the second duration is greater than the first duration. Both the station and the access point determine that the duration of the full-duplex TXOP is greater than the first duration, and the duration of the full-duplex TXOP is greater than the second duration. The duration of the full-duplex TXOP is prolonged, and a longer time channel is reserved for the full-duplex TXOP, so that the access point sends more data to the station.

The foregoing describes in detail the full-duplex data transmission method according to the embodiments of this application. The following describes a full-duplex data transmission apparatus in the embodiments of this application.

The embodiments of this application describe in detail a schematic structure of a full-duplex data transmission apparatus on an access point side.

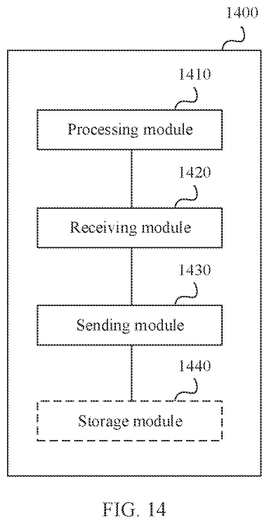

In an example, FIG. 14 is a schematic block diagram of a full-duplex data transmission apparatus 1400 on an access point side according to an embodiment of this application. The apparatus 1400 in this embodiment of this application may be the access point in the foregoing method embodiment, or may be one or more chips in an access point. The apparatus 1400 may be configured to perform some or all functions of the access point in the foregoing method embodiments. The apparatus 1400 may include a processing module 1410, a receiving module 1420, and a sending module 1430. Optionally, the apparatus 1400 may further include a storage module 1440.

For example, the receiving module 1420 may be configured to perform the step of the receiving action on the access point side in the foregoing method embodiment. For example, the receiving module 1420 is configured to perform step S13 in FIG. 3. The receiving module 1420 is configured to perform step S22 and step S24 in FIG. 7. The receiving module 1420 is configured to perform step S32 and step S35 in FIG. 10. The receiving module 1420 is configured to perform step S41, step S45, and step S49 in FIG. 12.

The sending module 1430 may be configured to perform the step of the sending action on the access point side in the foregoing method embodiment. For example, the sending module 1430 is configured to perform step S11 and step S12 in FIG. 3. The sending module 1430 is configured to perform step S21 and step S23 in FIG. 7. The sending module 1430 is configured to perform step S31, step S33, and step S34 in FIG. 10. The sending module 1430 is configured to perform step S42, step S47, step 548, and step S410 in FIG. 12.

The processing module 1410 may be configured to determine a transmission end time based on transmission duration. For example, the processing module 1410 is configured to perform steps S43 and S46 in FIG. 12.

Alternatively, the apparatus 1400 may also be configured as a general-purpose processing system, for example, referred to as a chip. The processing module 1410 may include one or more processors that provide a processing function. The receiving module 1420 may be, for example, an input interface, a pin, or a circuit. The sending module 1430 may be, for example, an output interface, a pin, or a circuit. The input/output interface may be responsible for information interaction between the chip system and the outside. The one or more processors may execute a computer executable instruction stored in the storage module, to implement the function of the access point in the foregoing method embodiment. In an example, the storage module 1440 optionally included in the apparatus 1400 may be a storage unit in the chip, for example, a register or a cache. The storage module 1440 may be alternatively a storage unit, for example, a read-only memory (read-only memory, ROM) or another type of static storage device that can store static information and an instruction, or a random access memory (random access memory, RAM), that is in the access point and that is located outside the chip.

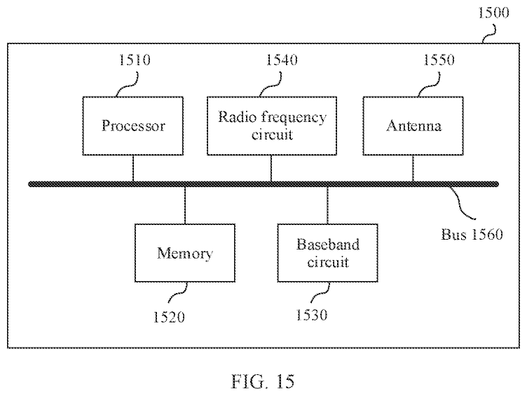

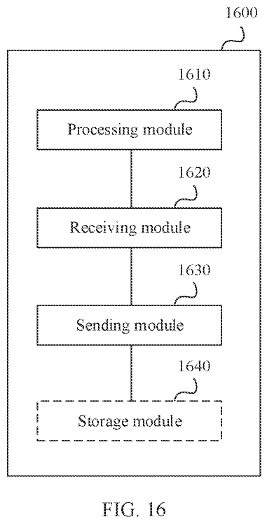

In another example, FIG. 15 is a schematic block diagram of another full-duplex data transmission apparatus 1500 on an access point side according to an embodiment of this application. The apparatus 1500 in this embodiment of this application may be the access point in the foregoing method embodiments, and the apparatus 1500 may be configured to perform some or all functions of the access point in the foregoing method embodiments. The apparatus 1500 may include a processor 1510, a baseband circuit 1530, a radio frequency circuit 1540, and an antenna 1550. Optionally, the apparatus 1500 may further include a memory 1520. Components of the apparatus 1500 are coupled together by using a bus 1560. In addition to a data bus, the bus system 1560 includes a power bus, a control bus, and a status signal bus. However, for clear description, various types of buses in the figure are marked as the bus system 1560.

The processor 1510 may be configured to control the access point, and configured to perform processing performed by the access point in the foregoing embodiments. The processor 1510 may perform a processing process related to the station in the foregoing method embodiments and/or configured to perform another process of the technology described in this application. Further, the processor 1510 may run an operating system, be responsible for managing the bus, and execute a program or an instruction stored in the memory.

The baseband circuit 1530, the radio frequency circuit 1540, and the antenna 1550 may be configured to support information receiving and sending between the access point and the station in the foregoing embodiments, to support wireless communication between the access point and the station. In an example, a data frame sent by the station is received by using the antenna 1550, processed by the radio frequency circuit through filtering, amplification, down-conversion, digitization, and the like, then processed by the baseband circuit baseband through baseband processing such as decoding and protocol-based data decapsulation, and processed by the processor 1510. In another example, a first signal of the access point may be processed by the processor 1510, processed by the baseband circuit 1530 through baseband processing such as protocol-based encapsulation and encoding, further processed by the radio frequency circuit 1540 through radio frequency processing such as analog conversion, filtering, amplification, and up-conversion, and transmitted by using the antenna 1550. The memory 1520 may be configured to store program code and data of the station, and the memory 1520 may be the storage module 1540 in FIG. 13. It can be understood that the baseband circuit 1530, the radio frequency circuit 1540, and the antenna 1550 may be further configured to support communication between the access point and another network entity, for example, communication between the station and a network element on a core network side.

It may be understood that, FIG. 15 shows only a simplified design of the access point. For example, in actual application, the access point may include any quantity of transmitters, receivers, processors, memories, and the like, and all access points that can implement the present invention fall within the protection scope of the present invention.

In a possible implementation, the full-duplex data transmission apparatus on the access point side may also be implemented by using the following: one or more field programmable gate arrays (field programmable gate array, FPGA), a programmable logic device (programmable logic device, PLD), a controller, a state machine, gate logic, a discrete hardware component, any other suitable circuit, or any combination of circuits that can perform various functions described throughout this application.

In another example, an embodiment of this application further provides a computer storage medium. The computer storage medium may store a program instruction used to indicate any one of the foregoing methods, so that a processor executes the program instruction to implement the method and the function that are related to the access point in the foregoing method embodiments.

In an example, FIG. 16 is a schematic block diagram of a full-duplex data transmission apparatus 1600 on a station side according to an embodiment of this application. The apparatus 1600 in this embodiment of this application may be the station in the foregoing method embodiment, or may be one or more chips in a station. The apparatus 1600 may be configured to perform some or all functions of the station in the foregoing method embodiments. As shown in FIG. 16, the apparatus 1600 may include a processing module 1610, a receiving module 1620, and a sending module 1630. Optionally, the apparatus 1600 may further include a storage module 1640.

For example, the processing module 1610 may be configured to perform processing on the data frame and the acknowledgment frame in the foregoing method embodiments. For example, the processing module 1610 is configured to perform step S25 and step S26 in FIG. 7. Alternatively, the processing module 1610 is configured to perform step S44 in FIG. 12.

The receiving module 1620 may be configured to perform the step of the receiving action in the foregoing method embodiment. For example, the receiving module 1620 is configured to perform step S11 and step S12 in FIG. 3. Alternatively, the receiving module 1620 is configured to perform step S21 and step S23 in FIG. 7. Alternatively, the receiving module 1620 is configured to perform step S31, step S33, and step S34 in FIG. 10. Alternatively, the receiving module 1620 is configured to perform step S42, step S47, step S48, and step S410 in FIG. 12.

The sending module 1630 may be configured to perform the step of the sending action in the foregoing method embodiment. For example, the sending module 1630 is configured to perform step S13 in FIG. 3. The sending module 1630 is configured to perform step S22 and step S24 in FIG. 7. The sending module 1630 is configured to perform step S32 and step S35 in FIG. 10. The sending module 1630 is configured to perform step S41, step S45, and step S48 in FIG. 12.

Alternatively, the apparatus 1600 may also be configured as a general-purpose processing system, for example, referred to as a chip. The processing module 1610 may include one or more processors that provide a processing function. The receiving module 1620 may be, for example, an input interface, a pin, or a circuit. The sending module 1630 may be, for example, an output interface, a pin, or a circuit. The input/output interface may be responsible for information interaction between the chip system and the outside. The processing module may execute a computer executable instruction stored in the storage module, to implement the function of the station in the foregoing method embodiment. In an example, the storage module 1640 optionally included in the apparatus 1600 may be a storage unit in the chip, for example, a register or a cache. The storage module 1640 may further be a storage unit, for example, a ROM, another type of static storage device that can store static information and an instruction, or a RAM, that is in the station and that is outside the chip.

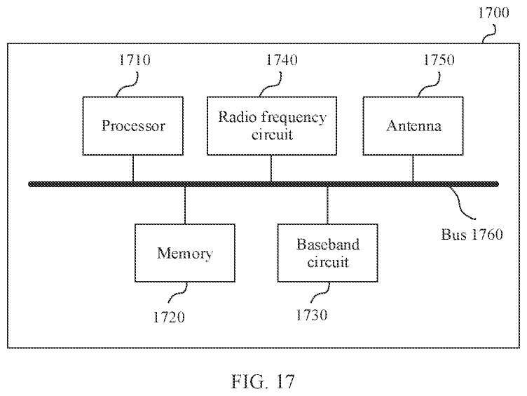

In another example, FIG. 17 is a schematic block diagram of another full-duplex data transmission apparatus 1700 on a station side according to an embodiment of this application. The apparatus 1700 in this embodiment of this application may be the station in the foregoing method embodiments, and the apparatus 1700 may be configured to perform some or all functions of the station in the foregoing method embodiments. The apparatus 1700 may include a processor 1710, a baseband circuit 1730, a radio frequency circuit 1740, and an antenna 1750. Optionally, the apparatus 1700 may further include a memory 1720. Components of the apparatus 1700 are coupled together by using a bus 1760. In addition to a data bus, the bus system 1760 includes a power bus, a control bus, and a status signal bus. However, for clear description, various types of buses in the figure are marked as the bus system 1760.

The processor 1710 may be configured to control the station, and configured to perform processing performed by the station in the foregoing embodiments. The processor 1710 may perform a processing process related to the station in the foregoing method embodiments and/or configured to perform another process of the technology described in this application. Further, the processor 1710 may run an operating system, be responsible for managing the bus, and execute a program or an instruction stored in the memory.

The baseband circuit 1730, the radio frequency circuit 1740, and the antenna 1750 may be configured to support information receiving and sending between the station and the access point in the foregoing embodiments, to support wireless communication between the station and the access point, and further configured to support signaling and information exchange between the station and another station, to implement coordination between stations.

In an example, an acknowledgment frame or a block acknowledgement frame sent by the access point is received through the antenna 1750, processed by the radio frequency circuit 1740 through processing such as filtering, amplification, down-conversion, and digitization, processed by the baseband circuit 1730 through baseband processing such as decoding and protocol-based data decapsulation, and processed by the processor 1710. In another example, a second data frame and an acknowledgment frame 2 that are generated by the processor 1710 processed by the baseband circuit 1730 through baseband processing such as protocol-based encapsulation and encoding, further processed by the radio frequency circuit 1740 through radio frequency processing such as analog conversion, filtering, amplification, and up-conversion, and transmitted by using the antenna 1750.

The memory 1720 may be configured to store program code and data of the station, and the memory 1720 may be the storage module 1740 in FIG. 15. It can be understood that the baseband circuit 1730, the radio frequency circuit 1740, and the antenna 1750 may be further configured to support communication between the station and another network entity. As shown in FIG. 17, the memory 1720 is separated from the processor 1710. However, a person skilled in the art very easily understands that the memory 1720 or any part of the memory 1720 may be located outside the apparatus 1700. For example, the memory 1720 may include a transmission cable and/or a computer product separated from a wireless node. The media may be accessed by the processor 1710 through the bus interface 1760. Alternatively, the memory 1720 or any portion thereof may be integrated into the processor 1710, for example, may be a cache and/or a general purpose register.

It may be understood that, FIG. 17 shows only a simplified design of the station. For example, in actual application, the station may include any quantity of transmitters, receivers, processors, memories, and the like, and all stations that can implement the present invention fall within the protection scope of the present invention.

In a possible implementation, the full-duplex data transmission apparatus on station side may also be implemented by using the following: one or more FPGAs, a PLD, a controller, a state machine, gate logic, a discrete hardware component, any other suitable circuit, or any combination of circuits that can perform various functions described throughout this application.

In another example, an embodiment of this application further provides a computer storage medium. The computer storage medium may store a program instruction used to indicate any one of the foregoing methods, so that a processor executes the program instruction to implement the method and the function that are related to the station in the foregoing method embodiments.

The processor in the apparatus 1500 and the apparatus 1700 may be a general-purpose processor, for example, a general-purpose central processing unit (CPU), a network processor (network processor, NP), or a microprocessor, or may be an application-specific integrated circuit (application-specific integrated circuit, ASIC), or one or more integrated circuits configured to control program execution in the solutions of this application. Alternatively, the processor may be a digital signal processor (digital signal processor, DSP), a field programmable gate array (field programmable gate array, FPGA) or another programmable logic device, a discrete gate or a transistor logic device, or a discrete hardware component. Alternatively, a controller/processor may be a combination of processors implementing a computing function, for example, a combination of one or more microprocessors, or a combination of the DSP and the microprocessor. The processor usually performs logical and arithmetic operations based on a program instruction stored in the memory.

The memory involved in the apparatus 1500 and the apparatus 1700 may further store an operating system and another application program. Specifically, the program may include program code, and the program code includes a computer operation instruction. More specifically, the memory may be a ROM, another type of static storage device that can store static information and an instruction, a RAM, another type of dynamic storage device that can store information and an instruction, a magnetic disk memory, or the like. The memory may be a combination of the foregoing memories. In addition, the computer-readable storage medium/memory may be located. in the processor, or may be located outside the processor, or distributed in a plurality of entities including a processor or a processing circuit. The computer-readable storage medium/memory may be specifically embodied in a computer program product. For example, the computer program product may include a computer-readable medium in a packaging material.

An embodiment of this application provides a communications system. The communications system includes the full-duplex data transmission apparatus on the access point side provided in FIG. 14 and the full-duplex data transmission apparatus on the station side provided in FIG. 16.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

A person of ordinary skill in the art may be aware that units and algorithm steps in the examples described with reference to the embodiments disclosed in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions of each particular application, but it should not be considered that the implementation goes beyond the scope of this application.

All or some of the foregoing embodiments may be implemented through software, hardware, firmware, or any combination thereof When software is used to implement the embodiments, the embodiments may be implemented completely or partially in a form of a computer program product. The computer program product includes one or more computer instructions. When the computer program instructions are loaded and executed on a computer, the procedure or functions according to this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive Solid State Disk), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A full-duplex data transmission method, comprising:
sending, by an access point, a first signal to at least one first station, wherein the first signal comprises information used to indicate at least one full-duplex transmit opportunity (TXOP);
sending, by the access point, a first data frame to the at least one first station based on the first signal; and
receiving, by the access point, a second data frame sent by at least one second station; and:
wherein transmission time intervals of the first data frame and the second data frame are comprised in a same full-duplex TXOP among the at least one full-duplex TXOP, and the transmission time intervals of the first data frame and the second data frame have a nonempty intersection set.

2. The method according to claim 1, wherein the first signal comprises a transfer request frame, and wherein the transfer request frame represents that the access point requests to send the first data frame to the at least one first station; and
after the sending, by an access point, a first signal to at least one first station, the method further comprises:
receiving, by the access point, a second signal sent by the at least one first station, wherein the second signal comprises a clear to send frame, and the clear to send frame represents that the at least one first station prepares to receive the first data frame.

3. The method according to claim 2, wherein the receiving, by the access point, a second data frame sent by at least one second station comprises:
receiving, by the access point, the second data frame sent by the at least one second station in a carrier sense multiple access with collision avoidance manner.

4. The method according to claim 1, wherein the first signal further comprises one or more of the following: first allow-to-send indication information, second allow-to-send indication information, or first indication information, wherein the first allow-to-send indication information is used to indicate whether the at least one second station is allowed to send uplink data in the at least one full-duplex TXOP, the second allow-to-send indication information is used to indicate whether the first station is allowed to send the uplink data in the at least one full-duplex TXOP, and the first indication information is used to indicate the second station ignores a state that shows a channel is busy in the at least one full-duplex TXOP.

5. The method according to claim 2, wherein the method further comprises:
sending, by the access point, a trigger frame for random access to the at least one second station, wherein the trigger frame for random access is used to indicate a resource block is used by the at least one second station to transmit the second data frame.

6. The method according to claim 2, wherein the first signal further comprises one or more of the following: second indication information, third indication information, or fourth indication information, wherein the second indication information is used to indicate the at least one full-duplex TXOP, the third indication information is used to indicate that only a station that does not receive the second signal is allowed to send uplink data, and the fourth indication information is used to indicate that a station whose receive power for receiving the second signal is less than a preset threshold is allowed to send the uplink data.

7. A full-duplex data transmission method, comprising:
receiving, by a second station, a first signal sent by an access point, wherein the first signal comprises information used to indicate at least one full-duplex transmit opportunity (TXOP);
generating, by the second station, a second data frame; and
sending, by the second station, the second data frame to the access point; and
wherein transmission time intervals of the second data frame and a first data frame are comprised in a same full-duplex TXOP among the at least one full-duplex TXOP, the first data frame is sent by the access point to at least one first station, and the transmission time intervals of the first data frame and the second data frame have a nonempty intersection set.

8. The method according to claim 7, wherein the first signal comprises a transfer request frame, and the transfer request frame represents that the access point requests to send the first data frame to the at least one first station.

9. The method according to claim 7, wherein the sending, by the second station, the second data frame to the access point comprises:
sending, by the second station, the second data frame to the access point in a carrier sense multiple access with collision avoidance manner.

10. The method according to claim 7, wherein the first signal further comprises one or more of the following: first allow-to-send indication information, second allow-to-send indication information, or first indication information, wherein the first allow-to-send indication information is used to indicate whether the second station is allowed to send uplink data in the at least one full-duplex TXOP, the second allow-to-send indication information is used to indicate whether the first station is allowed to send the uplink data in the at least one full-duplex TXOP, and the first indication information is used to indicate the second station ignores a state that shows a channel is busy in the at least one full-duplex TXOP.

11. The method according to claim 7, wherein the method further comprises:
receiving, by the second station, a trigger frame for random access sent by the access point, wherein the trigger frame for random access is used to indicate a resource block is used by the second station to transmit the second data frame.

12. The method according to claim 8, wherein the first signal further comprises one or more of the following: second indication information, third indication information, or fourth indication information, wherein the second indication information is used to indicate the at least one full-duplex TXOP, the third indication information is used to indicate that only a station that does not receive a second signal is allowed to send uplink data, the fourth indication information is used to indicate that a station whose receive power for receiving the second signal is less than a preset threshold is allowed to send the uplink data, the second signal is sent by the first station to the access point, the second signal comprises a clear to send frame, and the clear to send frame represents that the first station prepares to receive the first data frame.

13. A full-duplex data transmission apparatus on an access point side, comprising:
a transceiver;
a non-transitory memory storage comprising computer-executable instructions; and
one or more processors in communication with the transceiver and to the non-transitory memory storage, wherein the one or more processors execute the computer-executable instructions to cause the one or more processors to perform operations comprising:
sending, by an access point, a first signal to at least one first station, wherein the first signal comprises information used to indicate at least one full-duplex transmit opportunity (TXOP);
sending, by the access point, a first data frame to the at least one first station based on the first signal; and
receiving, by the access point, a second data frame sent by at least one second station: and:
wherein transmission time intervals of the first data frame and the second data frame are comprised in a same full-duplex TXOP among the at least one full-duplex TXOP, and the transmission time intervals of the first data frame and the second data frame have a nonempty intersection set.

14. The apparatus according to claim 13, wherein the first signal comprises a transfer request frame, and the transfer request frame represents that an access point requests to send the first data frame to the at least one first station; and
after sending the first signal to the at least one first station, the operations further comprise receiving a second signal sent by the at least one first station, wherein the second signal comprises a clear to send frame, and wherein the clear to send frame represents that the at least one first station prepares to receive the first data frame.

15. The apparatus according to claim 14, wherein the operations further comprise:
receiving the second data frame sent by the at least one second station in a carrier sense multiple access with collision avoidance manner.

16. The apparatus according to claim 13, wherein the first signal further comprises one or more of the following: first allow-to-send indication information, second allow-to-send indication information, or first indication information, wherein the first allow-to-send indication information is used to indicate whether the second station is allowed to send uplink data in the at least one full-duplex TXOP, the second allow-to-send indication information is used to indicate whether the first station is allowed to send the uplink data in the at least one full-duplex TXOP, and the first indication information is used to indicate the second station ignores a state that shows a channel is busy in the at least one full-duplex TXOP.

17. The apparatus according to claim 14, wherein the operations further comprise:
sending a trigger frame for random access to the at least one second station, wherein the trigger frame for random access is used to indicate a resource block is used by the at least one second station to transmit the second data frame.

18. The apparatus according to claim 14, wherein the first signal further comprises one or more of the following: second indication information, third indication information, or fourth indication information, wherein the second indication information is used to indicate the at least one full-duplex TXOP, the third indication information is used to indicate that only a station that does not receive the second signal is allowed to send uplink data, and the fourth indication information is used to indicate that a station whose receive power for receiving the second signal is less than a preset threshold is allowed to send the uplink data.
